(19) United States
(12) Patent Application Publication
(10) Pub. No.: US 2007/0141348 A1
(43) Pub. Date: Jun. 21, 2007

(54) Refractory material and its use, and method for treating refractory material

(76) Inventors: Andre Witzmann, WALDERSHOF (DE); Ulla Trinks, Mitterteich (DE); Reiner Artmann, Mitterteich (DE)

Correspondence Address: Striker Striker & Stenby, 103 East Neck Road, Huntington, NY, 11743, US

(21) Appl. No.: 10/594,284

(22) PCT Filed: Mar. 26, 2005
(86) PCT No.: PCT/EP05/03227

§ 371 Date: Sep. 26, 2006

(30) Foreign Application Priority Data
Mar. 30, 2004 (DE) 10 2004 015 357.4

(51) Int. Cl. B32B 17/10; C03B 11/08; B29C 59/16

(52) U.S. Cl. 428/409; 264/446; 264/482; 65/374.13

(57) ABSTRACT

The invention relates to a method for treating refractory material which consists of fireclay, light-weight refractory bricks, silimanite bricks, zirconium and zirconium-containing bricks, and fusion-cast bricks with compositions from Al₂O₃, SiO₂, ZrO₂ and/or MgO or CrO in order to render it corrosion-resistant so that it withstands contact with a glass melt for a longer time. The surface of the material is treated by laser radiation, forming a vitreous surface layer having a thickness of 100 to 1000 μm.

The present invention relates to a method for treating refractory material, the surface of which is preferably in contact with a glass melt. The present invention also relates to the refractory material itself, in particular applications of the refractory material, an apparatus for manufacturing and/or processing glass melts, and a method for manufacturing and/or processing glass melts.

In glass manufacture, glass tanks, feeder channels, blowpipes, drawing dies and the like are used, which are composed of refractory material or are clad with refractory material, and which must withstand the high temperatures of the glass melt.

Refractory material is understood to mean fireclay, light-weight refractory bricks, silimanite bricks, zirconium and zirconium-containing bricks, and fusion-cast bricks with compositions of Al₂O₃, SiO₂, ZrO₂ and/or MgO or CrO.

To a certain extent, these refractory materials have large pores, efflorescence, and high gas permeability, which negatively affect the glass melts because they can result in the formation of bubbles, crystals, stringy knots, stones, etc., or they can be incorporated into the melts. The mechanical processing of refractory materials can also cause pores to form which, via chemical attack by the glass melt, can result in corrosion of the refractory material. Since the glass melts, combustion gases, or port flames can corrode the refractory material, the staying times of the refractory material are not satisfactory, so that, after just a short period of use, the refractory material must be removed, which is costly.

Publication DE 102 44 040 C1 makes known sintered vitreous silica material for use in glass melt aggregates. This material, which does not fall under the definition of a refractory material stated above, has a two-layer construction and is composed of a fine-grained layer, which is in contact with the melt, and a coarse-grained layer. The fine-grained layer, which can also be vitrified via the effect of heat or specific contaminations with alkalies, is easily transformed into a cristobalite layer, which is more resistant to the melts, while the coarse-grained layer provides good mechanical strength. The manufacture of components of this type is complicated, however, and the material, which is composed entirely of SiO₂, is subjected to strong wear at higher temperatures, which occur, e.g., in the manufacture of special glasses.

The object of the present invention, therefore, is to provide a method for treating refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO which prevents the corrosion of refractory material and does not negatively affect the glass melts or the properties of the glass product. Another object of the present invention is to provide a corrosion-resistant refractory material.

Yet another object of the present invention is to provide special applications of the treated refractory material, an apparatus and a method for manufacturing and/or processing glass.

The method for treating refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO provides that the surface of the refractory material is treated by laser radiation.

It has been shown that the laser treatment minimizes the porosity and solidifies and hardens the surface by partially or completely vitrifying the siliceous components of the refractory material. It has been shown that the mechanical stresses produced via the reshaping of the surface layer do not negatively affect the mechanical strength of the surface layer.

The surface of the refractory material is preferably heated by the laser radiation to at least 2000° C. The method has the advantage that it is only the relevant surface—and not the entire material—that needs to be heated. An intensive source of thermal radiation (e.g., an H₂ or plasma torch or laser) is required to vitrify the surface. Laser radiation has the advantage that it offers high energy density, a defined forming of the hot spot, and very good adjustability and reproducibility of the heat output. The laser energy input is not bound to a medium, as is the case, e.g., with fast-flowing combustion gases, which can cause deformation of the melt layer that is forming, and can result in contaminations.

The energy density introduced into the surface is approximately 2-4 W/mm², in particular approximately 3 W/mm². The effective exposure time is 0.1 to 5 s, and preferably 0.5 to 3 s.

Advantageously, laser beams with a wavelength in the range of 9 to 11 μm are used.

Preferably, a CO₂ laser is used. CO₂ lasers have the advantage that the radiated wavelength is in the range of 10.6 μm. It has been shown that CO₂ lasers are the high-power lasers that are best adapted to the absorption properties of the refractory material. The laser treatment method also has the advantage that it does not generate by-products, e.g., COₓ or water vapour, which could negatively affect the surface, e.g., when H₂ torches are used.

Preferably, the surface is treated using a laser beam with a feed rate of 1-10 mm/s, while the laser beam on the surface has a diameter of 2-5 mm. As a result, energy densities in the range of 2-4 W/mm² are produced, which results in a closed, vitreous layer on the surface of the refractory material, without any material having been removed.

Depending on the type of glass, it is advantageous when the surface is sprayed before or during the laser treatment with a powder or a solution in water, alcohols, ketones, or others, which include the zirconium-containing and/or aluminium-containing compound. The surface layer is changed as a result such that an undesired crystallization of the contacting glass melt is prevented. In addition, the entire ceramic body can be infiltrated with solutions that include the zirconium-containing compounds.

The refractory material can be tempered as usual after the laser treatment.

The inventive refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO, the surface of which is preferably in contact with a glass melt, includes a surface treated by laser radiation.

The surface layer is preferably a closed vitreous layer, the main components of which are the components of the refractory material.

The thickness of the surface layer of the refractory material is preferably 100 to 1000 μm. It has been shown that thicknesses of this type are adequate to effectively prevent transport processes through this layer out of the refractory material into the glass melt, and vice versa.

The surface layer preferably contains zirconium and/or aluminium compounds. These compounds are located in the surface layer when a related powder or a solution is applied before or during the laser treatment.

Special uses of this refractory material composed of fireclay, light-weight refractory bricks, silimanite bricks, zirconium and zirconium-containing bricks, and fusion-cast bricks with compositions from Al₂O₃, SiO₂, ZrO₂ and/or MgO or CrO are to use the refractory material to form glass tanks, Danner blowpipes, feeder channels, and/or drawing dies.

Further uses are related to furnace construction, in particular the construction of glass melting furnaces and, in this case, apart from the glass tanks, pot furnaces, where the refractory material is used to increase the resistance to aggressive gases, high temperatures, etc.

The inventive apparatus for manufacturing and/or processing glass melts that includes the components in contact with the glass melt, the components being composed of refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO includes a surface treated by laser radiation. Apparatuses of this type have markedly longer staying times, thereby making it possible to markedly reduce the costs to replace refractory material in these apparatuses.

The method for manufacturing and/or processing glass melts provides that the glass melt is in contact with surfaces of refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO that have been treated by laser radiation.

Exemplary embodiments are explained below with reference to the figures.

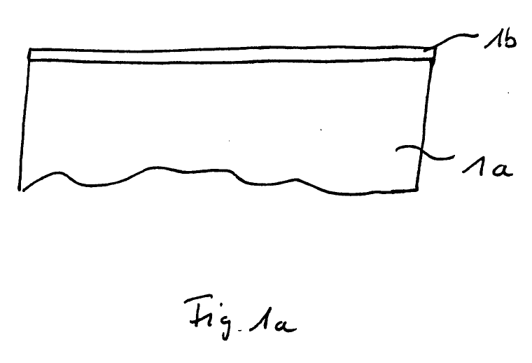

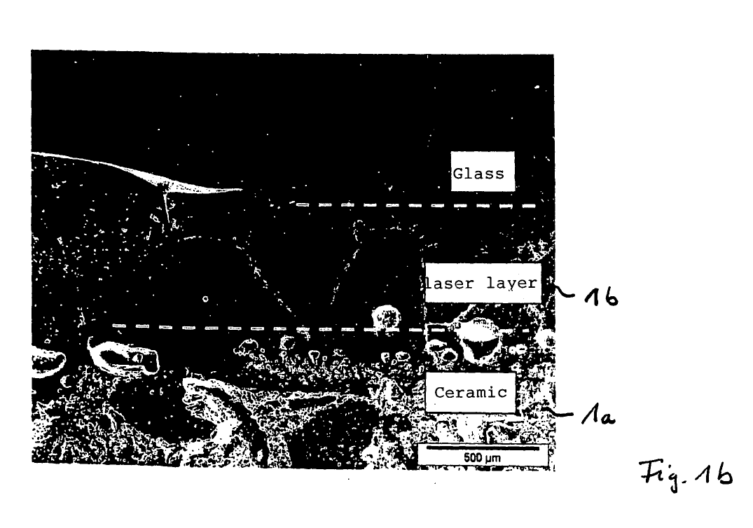

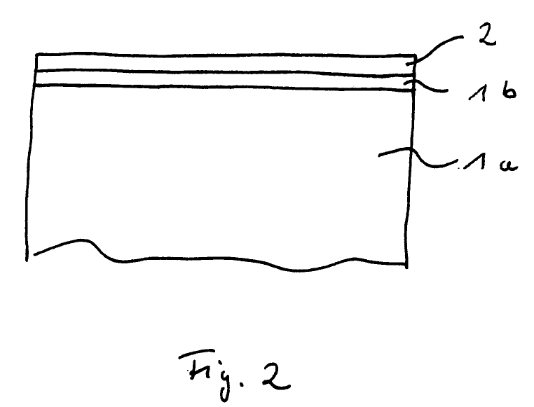

FIG. 1a shows a schematic cross section through the refractory material

FIG. 1b shows a REM photograph of refractory material with an adjacent glass layer.

In a test set-up, a refractory material of the type used for a Danner blowpipe was subjected to a laser beam treatment. A 100 W CO₂ laser with a beam diameter of approximately 4 mm was used for this purpose. Laser optics were moved with a Z-φ translation unit (2 mm increments) over the refractory material, thereby producing a slightly overlapping laser track on the refractory body. With a laser output of approximately 40 W, the feed rate was varied between 1.65 and 5 mm/s. A Danner blowpipe with a diameter of 190 mm was processed in this manner. Approximately 8 h were required to produce a circumferential strip 20 cm wide.

Subsequently, a glass melt was brought in contact with this refractory material. When loaded with a glass melt of approximately 1280° C., the vitreous layer that formed on the surface remained stable. When tools with a laser-treated surface are used, the overall changeover times required are shortened, tool corrosion is reduced, and the quality of the manufactured products is increased.

A cross-section through a refractory material 1a is shown schematically in FIG. 1a. The laser treatment causes a conversion to take place on the surface, thereby resulting in the formation of a vitreous surface layer 1b.

A REM photograph of a refractory layer of this type which has been laser-treated is shown in FIG. 1b. It is obvious that layer 1b, labeled “Laser layer”, has a much denser structure than layer 1a below it. The adjacent glass layer contains no bubbles.

What is claimed is:

1. A method for treating refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO, the surface of which is preferably in contact with a glass melt
wherein
the surface of the material is treated by laser radiation.

2. The method as recited in claim 1,
wherein
the surface of the refractory material is heated by the laser radiation to at least 2000° C.

3. The method as recited in claim 1,
wherein
an energy density of 2 to 4 W per mm² is introduced into the surface.

4. The method as recited in claim 1,
wherein
the laser treatment is carried out with an effective exposure time of 0.1 to 5 s.

5. The method as recited in claim 1,
wherein
the surface is treated using a laser beam with a feed rate of 1-10 mm/s, while the laser beam on the surface has a diameter of 2-5 mm.

6. The method as recited in claim 1,
wherein
a laser beam with a wavelength in the range of 9 to 11 μm is used.

7. The method as recited in claim 1,
wherein
a CO₂ laser is used.

8. The method as recited in claim 1,
wherein
the surface is sprayed with a powder or a solution before or during the laser treatment, or the ceramic body is infiltrated with a solution that contains the zirconium-containing and/or aluminium-containing compounds.

9. The method as recited in claim 1,
wherein
the refractory material is tempered after the laser treatment.

10. Refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO, the surface of which is preferably in contact with a glass melt, characterized by a surface treated by laser radiation.

11. The refractory material as recited in claim 10,
wherein
the refractory material (1a) has a vitreous surface layer (1b).

12. The refractory material as recited in claim 10,
wherein
the surface layer (1b) has a thickness of 100 to 1000 μm.

13. The refractory material as recited in claim 10,
wherein
zirconium-containing and/or aluminum-containing compounds are located in the surface layer (1b).

14. The use of a refractory material as recited in claim 10 for making furnaces, Danner blowpipes, for feeder channels and/or for drawing dies.

15. An apparatus for manufacturing and/or processing glass melts that includes the components in contact with the glass melt, the components being composed of refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO,
wherein
the refractory material includes a surface treated by laser radiation.

16. The method for manufacturing and/or processing glass melts,
wherein
the glass melt is in contact with surfaces of refractory material composed of fireclay, light-weight refractory bricks, silimanite bricks, zirconium and zirconium-containing bricks, and fusion-cast bricks with compositions of Al₂O₃, SiO₂, ZrO₂ and/or MgO or CrO that have been treated by laser radiation.
